(19) United States
(12) Patent Application Publication
(10) Pub. No.: US 2020/0217105 A1
(43) Pub. Date: Jul. 9, 2020

(54) ENCLOSURE LOCKS

(71) Applicant: HEWLETT-PACKARD DEVELOPMENT COMPANY, L.P., SPRING, TX (US)

(72) Inventor: WEI-MING WU, TAIPEI CITY (TW)

(21) Appl. No.: 16/633,983

(22) PCT Filed: Aug. 31, 2017
(86) PCT No.: PCT/US2017/049740

§ 371 Date: Jan. 24, 2020

(51) Int. Cl. E05B 65/00; E05B 73/00

(52) U.S. Cl. CPC E05B 65/0067; E05B 73/0082; E05B 73/0005

(57) ABSTRACT

In an example, an enclosure lock may include a lock port disposed in a device enclosure, the lock port to receive a device lock. The enclosure lock may also include a lock latch, which may be disposed within such a device enclosure. The lock latch may be movable from a released position to a locked position by the device lock if the device lock is engaged with the lock port. The lock latch may engage with an enclosure ledge of the device enclosure if the lock latch is disposed in the locked position such that the device enclosure is not able to be disassembled.

### BACKGROUND

Electronic devices may have a housing or enclosure within which components of the electronic device may be disposed. Such enclosures may protect and secure such components and/or provide positive aesthetic qualities to the electronic device. Further, in some situations, electronic devices may include an aperture or opening which may receive a removable device lock. Such device locks may securely engage with the enclosure in order to tether the electronic device to a surface, fixture, or other hard-to-move items so as to prevent and/or help deter theft of the electronic device.

### BRIEF DESCRIPTION OF THE DRAWINGS

FIG. 1 is a perspective view of an example enclosure lock.

FIG. 2A is a perspective cutaway view of an example device enclosure having an example enclosure lock.

FIG. 2B is a perspective cutaway view of an example device enclosure having an example enclosure lock.

FIG. 2C is a cross-sectional view of an example device enclosure having an example enclosure lock.

FIG. 3A is a top view of an example device enclosure having an example enclosure lock.

FIG. 3B is a top view of an example device enclosure having an example enclosure lock.

FIG. 4 is a cross-sectional view of an example device enclosure having an example enclosure lock.

FIGS. 5A-5C are a perspective views of an example electronic device having an example enclosure lock.

### DETAILED DESCRIPTION

Electronic devices may have a housing or enclosure within which components of the electronic device may be disposed. Such enclosures may protect and secure such components and/or provide positive aesthetic qualities to the electronic device. Further, such enclosures or housings may have panels or other portions which may be removable, opened, or able to be disassembled from the rest of the enclosure. Such panels or portions may provide access to components within the electronic device for the purpose of assembly, repair, replacement, upgrades, etc. Some enclosures may have panels that are relatively easy to remove, for example, through the use of a latch, switch, or another mechanism which may be actuated without the use of tools. Other enclosures may have panels that are fastened to the remainder of the enclosure with screws, pins, clips, or other mechanical fasteners, thereby necessitating the use of tools in order to remove such panels.

In some situations or use cases, it may be desirable to secure electronic devices to a surface, desk, table, or other hard-to-move items so as to prevent and/or help deter theft or loss of the electronic device. In such situations, a device lock may be employed to secure the electronic device in such a manner. Device locks may securely engage with the enclosure of the electronic device, and, in some situations, may be inserted into a lock port disposed in the enclosure of the electronic device. Such device locks may include a device portion to interface with the enclosure, and also a securing portion, e.g., a cable, to interface with the surface or item to which the electronic device is to be secured or tethered.

Even though a device lock may be employed to secure an electronic device to an item or a location, panels or portions of the enclosure of the electronic device may still be able to be disassembled or opened, at least partially, and provide an unauthorized party access to components and parts disposed within the electronic device. Such unauthorized access may enable such a party to damage or remove components from the electronic device, and, therefore, proposes a security weakness or threat to the electronic device. As such, it may be desirable to not only secure an electronic device to an item or location with a device lock, but to also further secure the enclosure of the electronic device, and prevent unauthorized removal or disassembly of removable panels or portions of the electronic device.

Implementations of the present disclosure provide enclosure locks which may be used in conjunction with device locks to both secure an electronic device to an item and/or location, as well as to secure the enclosure of the electronic device to prevent the enclosure from being opened or disassembled, thereby increasing the security of the electronic device. Such examples of enclosure locks prevent or hinder an unauthorized party from gaining access to components or parts disposed within the enclosure of an electronic device.

Referring now to FIG. 1, a perspective view of an example enclosure lock 100 is illustrated. Example enclosure lock 100 may include a lock port 102 disposed in a device enclosure 101, the lock port 102 to receive a device lock. The device enclosure 101 is illustrated as a cutaway view in order to show components disposed within the device enclosure 101. The enclosure lock 100 may also include a lock latch 106, which may be disposed, at least partially, within such a device enclosure 101. The lock latch 106 may be movable from a released position to a locked position, illustrated by arrow 107, by the device lock if the device lock is engaged with the lock port 102. The lock latch 106 may engage with an enclosure ledge 118 of the device enclosure 101 if the lock latch 106 is disposed in the locked position such that the device enclosure 101 is not able to be disassembled.

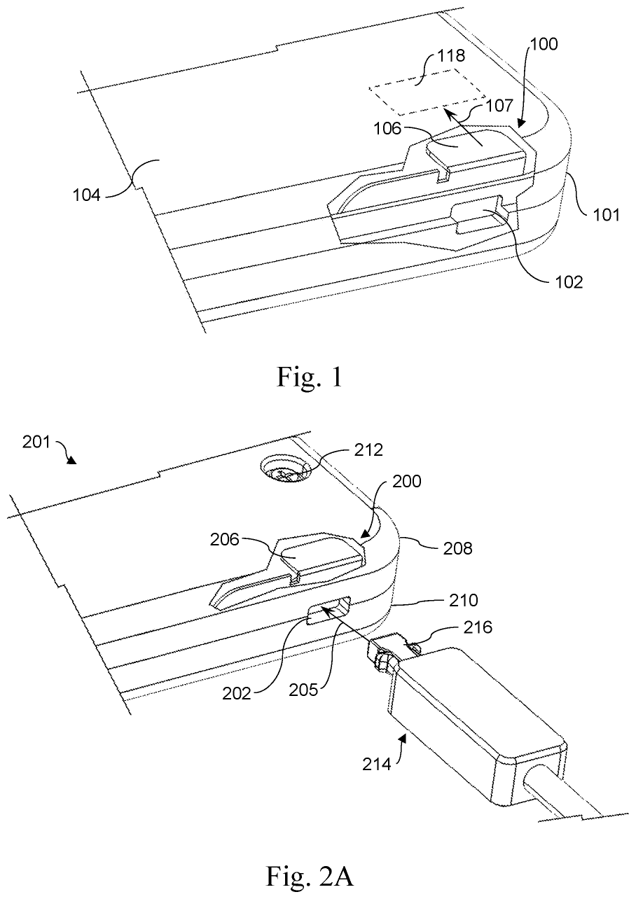

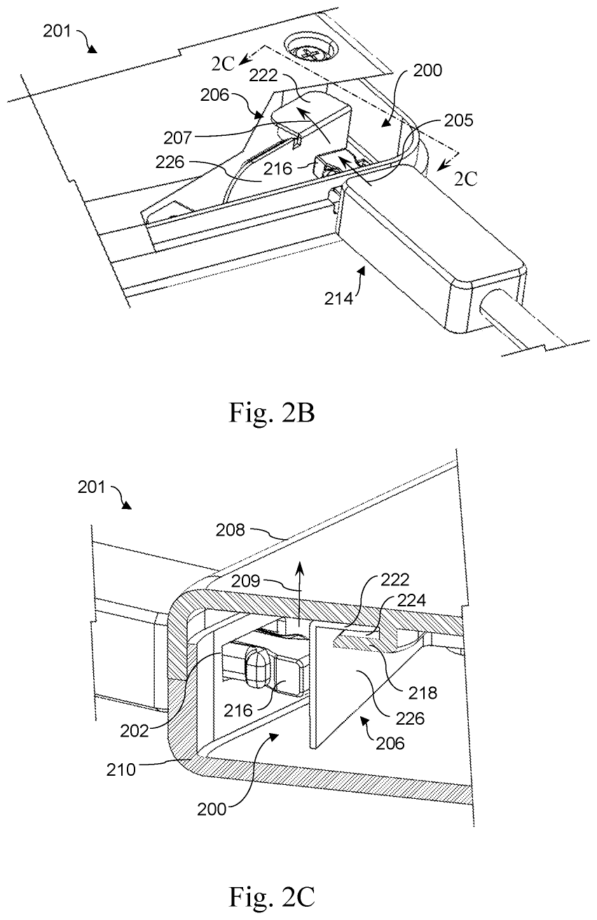

Referring now to FIG. 2, a perspective cutaway view of an example device enclosure 201 having an example enclosure lock 200 is illustrated. Example enclosure lock 200 may be similar to example enclosure lock 100, described above. Further, the similarly-named elements of example enclosure lock 200 may be similar in function and/or structure to the respective elements of example enclosure lock 100, as they are described above. Device enclosure 201 may be a housing or other exterior structure of an electronic device. Device enclosure 201 may mechanically support components disposed within the electronic device, protect such components from exterior contaminants or damage, and/or provide a positive aesthetic quality to the electronic device, among other functions. In some implementations of the present disclosure, the device enclosure 201 may include a first enclosure portion 208 and a second enclosure portion 210, which may be assembled to or mated to the first enclosure portion 208, or vice versa, to define the device enclosure 201, or a portion thereof, and/or to define an enclosure interior. Components of the electronic device may be disposed within the enclosure interior. In further implementations, the first enclosure portion 208 may be a removable panel, or may be able to be disassembled from the second enclosure portion 210, or vice versa. In some implementations, the first enclosure portion 208 and the second enclosure portion 210 may be held together by mechanical fasteners 212, or may be held together by another mechanism, such as a clasp, latch, clips, or other suitable components. In the illustrated example, mechanical fasteners 212 may be accessed from the exterior of the device enclosure 201, and may be actuated or removed with common tools, for example, a screwdriver. As such, without the use of example enclosure locks described herein, the device enclosure may be able to be disassembled by any party so desiring, even if the electronic device is secured with a device lock.

Referring still to FIG. 2A, the device enclosure 201 may further include a lock port 202 which may be or may have an aperture or opening extending through the first enclosure portion 208 and/or the second enclosure portion 210 into the enclosure interior. In some implementations, the lock port 202, or the aperture thereof, may be defined by a first opening in the first enclosure portion 208 and a second opening in the second enclosure portion 210. In other words, the first opening may be a cutout from an edge of the first enclosure portion 208, and the second opening may be a cutout in the second enclosure portion 210 and may align with the first opening such that, when the first enclosure portion 208 and the second enclosure portion 210 are mated, the first opening and the second opening collectively define the lock port 202, or the aperture thereof. In some implementations, the lock port 202 may be considered to be a part of the enclosure lock 200. The lock port 202 may be able to receive a device lock 214, or a locking portion 216 thereof. The device lock 214 or the locking portion 216 may be inserted into the lock port 202, illustrated by example direction 205, and actuated so as to secure the locking portion 216 within the lock port 202, and thus securing the device lock 214 to the device enclosure 201. In other words, the lock port 202, or the aperture thereof, may allow the device lock 214 to extend into the enclosure interior. In some implementations, the device lock 214 may be a Kensington lock (or “K-Lock”) commonly used to secure electronic devices to items or locations. In other implementations, the device lock 214 may be another type of lock and the lock port 202 may have a sufficient size and/or structure to receive and accommodate such another type of lock.

The enclosure lock 200 may include a lock latch 206, which may be disposed, at least partially, within the device enclosure 201, or in other words, within the enclosure interior. The lock latch 206, or a portion thereof, may be disposed adjacent to the lock port 202, and may be movable between a released position, illustrated in FIG. 2A, and a locked position, illustrated in FIG. 2B. Referring additionally to FIG. 2B, a perspective cutaway view of example device enclosure 201 is illustrated, wherein the lock latch 206 has been moved or transitioned from the released position to the locked position. The locking portion 216 of the device lock 214 has been inserted into the lock port 202 along direction 205 and contacted the lock latch 206 so as to move the lock latch 206 along example direction 207 from the released position to the locked position. Stated differently, the device lock 214 may push the lock latch 206 from the released position to the locked position if the device lock 214 is inserted into the lock port 202. The lock latch 206 may be a rigid or semi-rigid member or beam, and may have a lock tab 222. The lock latch 206 may also include a contact portion 226 which may engage with the device lock 214, or the locking portion 216 thereof. In some implementations, the lock tab 222 may extend from the contact portion 226 in a substantially perpendicular manner so as to define a partial T-shaped, or L-shaped, structure. In other implementations, the lock tab 222 may extend from another portion of the lock latch 206, or may extend from the contact portion 226 in a manner other than substantially perpendicular, for example, at an oblique angle. In further implementations, the lock tab 222 may be a unitary part of the lock latch 206, and, in other implementations, the lock tab 222 may be a discrete or separate component that may be attached or assembled to the lock latch 206. In yet further implementations, the lock tab 222 may be indirectly engaged with the lock latch 206, for example through intermediary components, such that, upon the contact portion 226 being moved, the lock latch 222 moves in a corresponding manner. Upon the device lock 214 engaging with and being inserted into the lock port 202, the locking portion 216 may contact and press against the contact portion 226 of the lock latch 206 in order to move the lock latch 206 to the locked position.

Referring additionally to FIG. 2C, a cross-sectional view of the example device enclosure 201 taken along view line 2C-2C of FIG. 2B is illustrated. The locking portion 216 of the device lock 214 has urged or pushed on the contact portion 226 of the lock latch 206 so as to transition the lock latch 206 to the locked position, thereby engaging the lock tab 222 with an enclosure ledge 218. The enclosure ledge 218 may extend from the first enclosure portion 208 into the enclosure interior so as to define a ledge cavity 224 sized and structured sufficiently so as to receive the lock tab 222. In some implementations, the enclosure ledge 218 may have a J-shape, L-shape, or another curved structure so as to define the ledge cavity 224. In further implementations, the enclosure ledge 218 may define a pocket within which the lock tab 222 may be received. Upon the lock latch 206 being disposed in the locked position, the lock tab 222 may be disposed within the ledge cavity 224 such that the engagement of the enclosure ledge 218 with the lock tab 222 prevents the first enclosure portion 208 from being separated from the second enclosure portion 210, for example, along direction 209. In other words, the lock latch 206 may be sufficiently fixed to the second enclosure portion 210, and the lock tab 222 may be sufficiently disposed within the ledge cavity 224 when the lock latch 206 is in the locked position, that the lock latch 206 prevents the device enclosure 201 from being taken apart, moving apart, separated, or otherwise disassembled. Therefore, the device lock 214, upon being engaged with the device enclosure 201, may actuate the enclosure lock 200 such that the enclosure lock 200 secures the device enclosure 201 and prevents access to the enclosure interior by an unauthorized party.

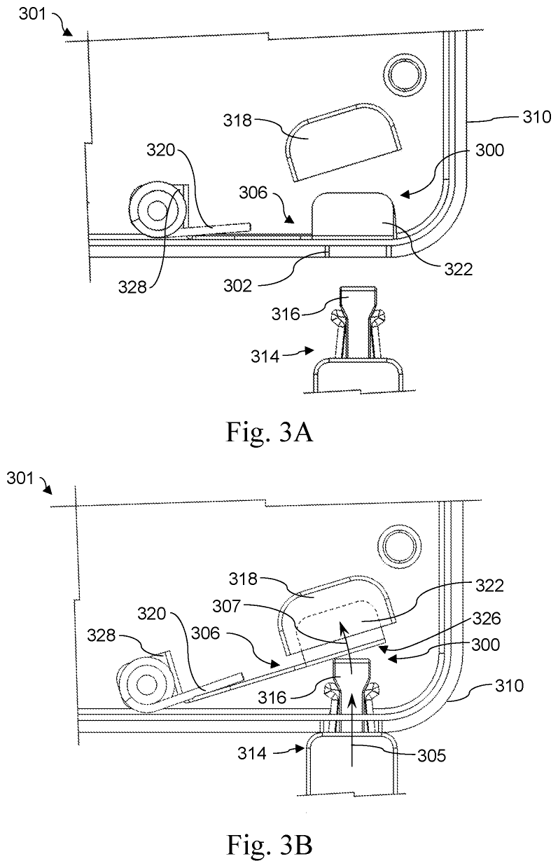

Referring now to FIG. 3A, a top view of an example device enclosure 301 having an example enclosure lock 300 is illustrated. Example enclosure lock 300 and device enclosure 301 may be similar to other example enclosure locks and device enclosures, as they are described above. Further, the similarly-named elements of example enclosure lock 300 and device enclosure 301 may be similar in function and/or structure to the respective elements of other example enclosure locks and device enclosures, as they are described above. Example device enclosure 301 may have a first enclosure portion and a second enclosure portion 310. FIGS. 3A-B omit the first enclosure portion so as to clearly illustrate the components disposed within the device enclosure 301 and the functions thereof. It should be noted that the first enclosure portion may include an enclosure ledge 318 fixed or attached to the first enclosure portion, and that the enclosure ledge 318 is still illustrated in FIGS. 3A-B.

The enclosure lock 300 may include a lock latch 306 having a lock tab 322, and a lock port 302 disposed in the device enclosure 301. The lock port 302 may be or may have an aperture to receive a device lock 314, or a locking portion 316 thereof. The lock latch 306 may be disposed within an enclosure interior of the device enclosure 301 and may be pivotably engaged with or attached to the device enclosure 301, or the second enclosure portion 310 thereof. The lock latch 306 may be pivotably engaged with the device enclosure 301 at a pivoting end 328. Further, the lock tab 322 may be disposed at a locking end, opposite from, or otherwise away from, the pivoting end 328. The lock latch 306 may pivot between a released position, illustrated in FIG. 3A, and a locked position, illustrated in FIG. 3B. In some implementations, the lock latch 306, or a contact portion 326 thereof, may be disposed in front of and/or adjacent to the lock port 302 and/or the aperture thereof when disposed in the released position. Further, the lock latch 306 may be disposed away from the lock port 302, or the aperture thereof, when disposed in the locked position.

In some implementations, the enclosure lock 300 may further include a bias member 320, which may be engaged with the lock latch 306. The bias member 320 may be a resilient member capable of returning to its original shape after undergoing a deformation. In other words, the bias member 320 may be elastically deformable, or may otherwise have elastic properties. In some implementations, the bias member 320 may be a spring, or in further implementations, may be a torsion spring. In other implementations, the bias member 320 may be another type of spring. The bias member 320 may urge or bias the lock latch 306 towards the released position.

Referring additionally to FIG. 3B, a top view of example device enclosure 301 is illustrated wherein the lock latch 306 has been moved or pivoted from the released position to the locked position. The device lock 314, or the locking portion 316 thereof, has been inserted into, and received by, the lock port 302, for example along direction 305, and has pressed against the contact portion 326 of the lock latch 306 to cause the lock latch 306 to pivot about the pivoting end 328, against the urging of the bias member 320, along direction 307. The lock latch 306 has pivoted along direction 307 to the locked position, wherein the lock tab 322 has engaged with or latched on to the enclosure ledge 318, which may be disposed within the enclosure interior. Upon being engaged with the enclosure ledge 318, the lock latch 306 prevents the device enclosure 301 from being opened or separated, as described above. Additionally, the bias member 320 is urged against the lock latch 306 such that, upon removal of the device lock 314 from the lock port 302, the bias member 320 may move the lock latch 306 from the locked position back to the released position.

It should be noted that, while the lock latch 306 is illustrated herein as moving in an arcuate manner, or pivoting, parallel to the view plane of FIGS. 3A-B in order to transition between the released position and the locked position, other manners of movement of the lock latch 306 are contemplated. For example, in some implementations, the lock latch 306 may pivot in another direction or dimension in order to transition to the locked position, e.g., a direction into or intersecting with the view plane of FIGS. 3A-B. In another example, it is contemplated that the lock latch 306 may translate in a single direction or dimension to transition to and from the locked position, e.g., the lock latch may slide directly forward and back instead of pivoting about an axis of rotation.

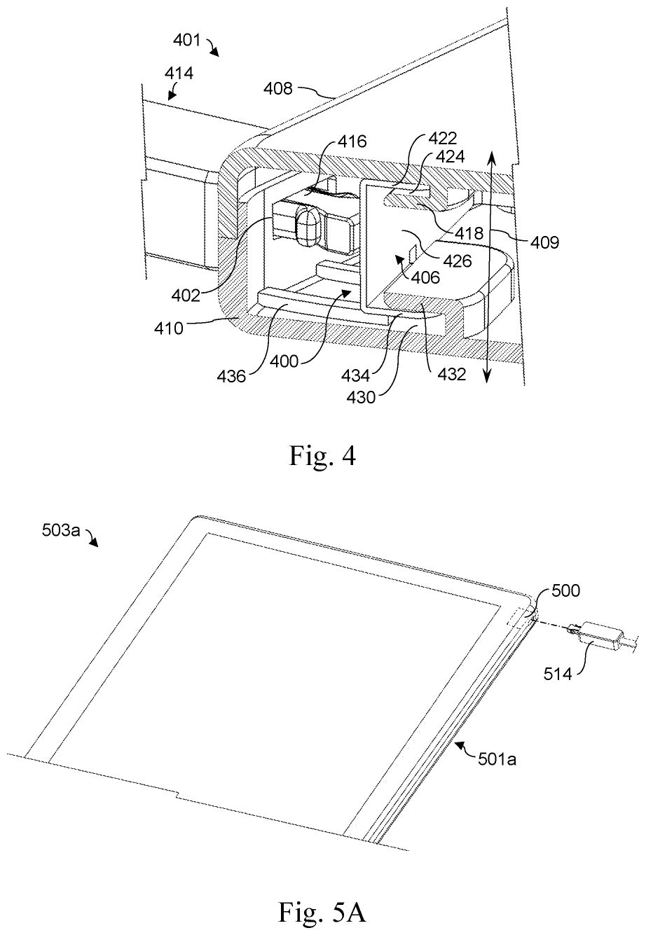

Referring now to FIG. 4, a cross-sectional view of an example device enclosure 401 having an example enclosure lock 400 is illustrated. Example enclosure lock 400 and device enclosure 401 may be similar to other example enclosure locks and device enclosures, as they are described above. Further, the similarly-named elements of example enclosure lock 400 and device enclosure 401 may be similar in function and/or structure to the respective elements of other example enclosure locks and device enclosures, as they are described above. The device enclosure 401 may include a lock port 402 extending through the device enclosure, or a first enclosure portion 408 and/or a second enclosure portion 410 thereof, into an enclosure interior. The lock port 402 may receive and enable a device lock 414, or a locking portion 416 thereof, to extend into the enclosure interior and engage with, or push on a lock latch 406, or a contact portion 426 thereof, of the enclosure lock 400. The device lock 414 may push the lock latch 406 from a released position to a locked position.

The first enclosure portion 408 may include a first enclosure ledge 418, and the second enclosure portion 410 may include a second enclosure ledge 432. The first enclosure ledge 418 and the second enclosure ledge 432 may each extend into the enclosure interior from the first enclosure portion 408 and the second enclosure portion 410, respectively, towards each other. In some implementations, each of the first enclosure ledge 418 and the second enclosure ledge 432 may extend into the enclosure interior in a hook-like manner to define a first ledge cavity 424 and a second ledge cavity 430, respectively.

The lock latch 406, in some implementations, may include a first lock tab 422 and a second lock tab 434. Each of the first lock tab 422 and the second lock tab 434 may extend from the lock latch 406, or a contact portion 426 thereof, so as to define a U-shape, double L-shape, or another suitable shape to enable the first lock tab 422 and the second lock tab 434 to latch on to or engage with the first enclosure ledge 418 and the second enclosure ledge 432, respectively. In other words, the first lock tab 422 may engage with the first enclosure ledge 418, or a first ledge cavity 424 defined thereby, and the second lock tab 434 may engage with the second enclosure ledge 432, or a second ledge cavity 430 defined thereby, if the lock latch 406 is disposed in the locked position. The lock latch 406, upon being disposed in the locked position, may engaged with the first lock tab 422 and the second lock tab 432 so as to prevent the device enclosure 401, or the first enclosure portion 408 and the second enclosure portion 410 thereof, from being disassembled or unmated, for example along direction 409. Thus, when the lock latch 406 is disposed in the locked position, the enclosure lock 400 prevents the device enclosure 401 from being opened, for example, by an unauthorized party.

In some implementations, the enclosure lock 400 may include guide members 436 upon which the lock latch 406, or a lock tab thereof, may slide. Guide members 436 may be protrusions from the first enclosure portion 408 and/or the second enclosure portion 410, in some implementations. Such guide members 436 may enable the smooth and efficient transition of the lock latch 406 between the released position and the locked position.

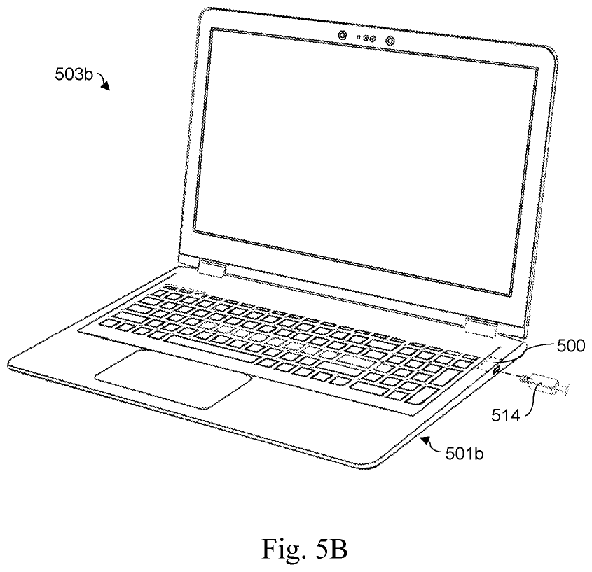

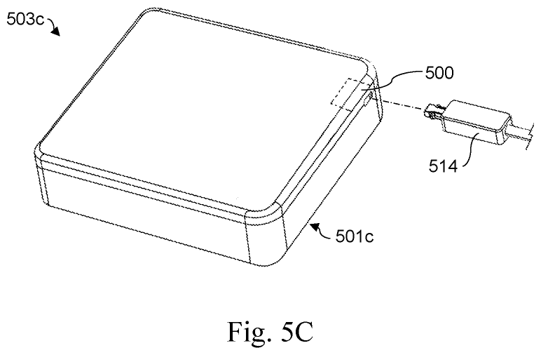

Referring now to FIGS. 5A-C, perspective views of example electronic devices 503a-c (referred to collectively as electronic devices 503) having example enclosure locks 500 are illustrated. Example enclosure locks 500 may be similar in function and structure to other example enclosure locks described above. Electronic devices 503 may be any electronic device which may benefit from engaging with a device lock 514 to secure such an electronic device to an item or location, and may each have a corresponding device enclosure 501a-c (referred to collectively as device enclosures 501). Such electronic devices 503 may also benefit from employing an example enclosure lock 500 (illustrated in phantom lines) within the corresponding device enclosures 501 to prevent unauthorized access to an enclosure interior, and/or components disposed within. Upon engaging the device lock 514 with the device enclosures 501 of the electronic devices 503, the device lock 514 may push on a lock latch of the enclosure lock 500 which, in turn, may engage with an enclosure ledge within the corresponding device enclosure, thereby preventing the device enclosure from being taken apart or disassembled.

In some implementations, the electronic device may be a computing device. In further implementations, the electronic device may be a tablet computer or slate, as illustrated by electronic device 501a in FIG. 5A. In other implementations, the electronic device may be a notebook computer or clamshell computer, as illustrated by electronic device 501b in FIG. 5B. In yet other implementations, the electronic device may be another type of electronic device, illustrated generally by electronic device 501c in FIG. 5C. Such electronic device 501c may be a small form factor, mini, or micro desktop computer in some implementations. In other implementations, electronic device 501c may be an Internet modem or router, a cable or satellite set-top box, a device to provide smart-TV capabilities to a television, a portable hard drive, or another type of electronic device.

What is claimed is:

1. An enclosure lock, comprising:
a lock port disposed in a device enclosure to receive a device lock; and
a lock latch disposed within the device enclosure and movable from a released position to a locked position by the device lock if the device lock is engaged with the lock port,
wherein the lock latch is to engage with an enclosure ledge of the device enclosure if the lock latch is disposed in the locked position such that the device enclosure is not able to be disassembled.

2. The enclosure lock of claim 1, wherein the device lock is to push the lock latch from the released position to the locked position if the device lock is inserted into the lock port.

3. The enclosure lock of claim 2, wherein the lock latch is pivotably engaged with the device enclosure so as to pivot between the released position and the locked position.

4. The enclosure lock of claim 3, wherein the lock latch is pivotably engaged with the device enclosure at a pivoting end and wherein the lock latch includes a lock tab to engage with the enclosure ledge, the lock tab disposed at a locking end, opposite from the pivoting end.

5. The enclosure lock of claim 3, further comprising a bias member engaged with the lock latch, the bias member to bias the lock latch towards the released position.

6. The enclosure lock of claim 5, wherein the bias member is urged against the lock latch so as to move the lock latch from the locked position to the released position if the device lock is removed from the lock port.

7. A device enclosure, comprising:
a first enclosure portion having a first enclosure ledge;
a second enclosure portion having a second enclosure ledge and assembled to the first enclosure portion to define an enclosure interior,
wherein the first enclosure ledge and the second enclosure ledge extend into the enclosure interior towards each other;
a lock port having an aperture extending into the enclosure interior to receive a device lock; and
an enclosure lock having a lock latch disposed within the enclosure interior and disposed adjacent to the lock port, the lock latch movable from a released position to a locked position,
wherein the lock latch is to engage with the first enclosure ledge and the second enclosure ledge if disposed in the locked position such that the first enclosure portion and the second enclosure portion cannot be disassembled.

8. The device enclosure of claim 7, wherein the lock latch includes a first lock tab to engage with the first enclosure ledge, and a second lock tab to engage with the second enclosure ledge if the lock latch is disposed in the locked position.

9. The device enclosure of claim 7, wherein the aperture of the lock port is to receive a locking portion of the device lock.

10. The device enclosure of claim 9, wherein the aperture of the lock port is defined by a first opening in the first enclosure portion and a second opening in the second enclosure portion.

11. The device enclosure of claim 10, wherein the device lock is a Kensington lock.

12. An electronic device, comprising:
a device enclosure, comprising:
a first enclosure portion;
a second enclosure portion mated with the first enclosure portion; and
a lock port disposed in the device enclosure and having an aperture to allow a device lock to extend into an enclosure interior; and
an enclosure lock comprising a lock latch disposed within the enclosure interior and pivotably attached to the device enclosure, the lock latch to pivot between a released position, disposed in front of the lock port aperture, and a locked position, disposed away from the lock port aperture,
wherein, if disposed in the locked position, the lock latch is to latch on to an enclosure ledge within the enclosure interior so as to prevent the first enclosure portion and the second enclosure portion from moving apart from one another.

13. The electronic device of claim 12, wherein the device lock is to push the lock latch from the released position to the locked position if the device lock is inserted into the aperture of the lock port.

14. The electronic device of claim 12, wherein the electronic device is a notebook computer.

15. The electronic device of claim 12, wherein the electronic device is a tablet computer.
